(19) United States
(12) Patent Application Publication
(10) Pub. No.: US 2026/0318196 A1
(43) Pub. Date: Oct. 15, 2026

(54) MONITORING DEVICE AND METHOD FOR MONITORING A POSSIBLE OVER-/UNDER-REMOVAL OF SOIL WHEN DRILLING A BOREHOLE IN THE SOIL

(71) Applicant: HERRENKNECHT AG, Schwanau (DE)

(72) Inventors: Frederic Seng, Kenzingen (DE); Hans-Peter UFFMANN, Aachen (DE)

(21) Appl. No.: 19/469,855

(22) PCT Filed: Mar. 19, 2024
(86) PCT No.: PCT/EP2024/057356

§ 371 Date: Sep. 26, 2025

(30) Foreign Application Priority Data
Mar. 29, 2023 (DE) 10 2023 108 063.6

(51) Int. Cl. E21B 49/00; G01B 5/12; G01B 21/22

(52) U.S. Cl. CPC E21B 49/00; G01B 5/12; G01B 21/22

(57) ABSTRACT

The invention relates to a monitoring device for monitoring a removal quantity of loosened soil and/or an overcut for creating an annular space when creating a borehole in the soil (10) by means of an advance of a drilling device (20), wherein: the monitoring device can be arranged below an opening (25) in a peripheral wall (3) of a drilling device (20) or below an opening in an outer wall of a pipe portion of a drilling device or of a casing pipe; the drilling device (20) is a drilling device for creating a borehole in the soil from a start point to a target point; the monitoring device (30) comprises a receptacle (4) which has an inner space (33) and an entry opening for arrangement in the region of the opening (25); the monitoring device (30) comprises a control element (5) which is arranged in the inner space (33) so as to be pivotable about a pivot axis (6); an actuator is provided in connection with the control element (5); the control element (5) is movable in a pivot direction (A) via the actuator (11); the control element (5) comprises a pivot region, so that the control element (5) is movable through the entry opening; and the control element (5) comprises at least one contact surface (9) which, in the pivoted-out state of the control element (5), is in contact with the borehole wall (13)/the soil (10).

The invention relates to a monitoring device to be arranged below an opening in a circumferential wall of a boring device, the boring device being a boring device for creating a bore in the soil from a starting point to a destination point, having a gauge element, an actuator for moving the gauge element being provided, which has a contact surface which is in contact with the borehole wall of the bore/the soil when the gauge element is deployed. The invention furthermore relates to a boring device with such a monitoring device and to a method for monitoring possible over/under-removal of soil during the boring of the bore in the soil.

The underground installation of pipes by means of pipe jacking is now an underground civil engineering technique that has been established for many decades. Owing to progress particularly in the last 30 years, jacking has successfully been carried out up to 2000 m in length with diameters of up to nearly 5 meters, sometimes near the surface. The jacking techniques essentially differ by the type of extraction of soil or rock at the so-called face. The extracted material, referred to below as spoil, may be transported from the face to the launch shaft in various ways, for example in buckets, via screw transport, via belt transport or alternatively liquid transport by means of a carrier liquid such as water or a bentonite suspension.

During underground line laying, for example by pipe jacking, individual successively arranged pipes of concrete, stoneware or the like, or an entire already connected steel pipeline are pushed into the soil. Arranged at the tip of the pipe run, there is a boring machine that loosens and fragments the soil (breaks down larger stones) and delivers the extracted material to a conveyor device. The distance tunneled is furthermore determined via control events in the boring machine. The boring machine moreover contains control cylinders, which generate an angulation of the boring machine and thereby make it possible to negotiate curves. The required forces that are needed for inserting the boring machine and the pipe run into the soil must be greater than the peak pressure at the boring machine, in particular at the cutting wheel, and the sum of the skin friction, which is given by the skin surface of the pipe run and the contact with the surrounding geology.

In order to reduce the skin friction, the boring machine bores a borehole that is enlarged to a certain extent with respect to the outer diameter of the pipe run. The annular gap created in this way is filled with lubricating suspensions.

It may be expedient to gauge this annular gap according to the soil conditions, since removing too much soil material during the boring may generate an excessively large borehole or even cavities in the subsoil, which can lead to subsidence on the surface. Removing too little of the soil material may in turn with simultaneous advancing of the pipe run lead to displacements of the soil in front of the boring machine and to elevations on the surface.

During the boring, it can therefore be advantageous to compare the rate of advance with the amount of spoil. Particularly when jacking in unstable soil below ground water, over-removal of spoil may be problematic. If the volume that the spoil occupies in the soil exceeds the volume of the boring device and the pipes that are introduced, depending on the extent of the over-removal or under-removal, subsidence even to the extent of large surface fracture, or humps, may occur, which can cause significant damage to surface buildings, roads and possibly existing underground infrastructure. This damage often occurs only with a considerable time delay, depending on the overlying soil and the depth of the tunnel.

It is known to gauge the volume of the spoil transported away. In this case, however, the accuracies that would be necessary to reliably prevent undesired consequences of incorrect spoil removal are not achieved. The known methods include quantity and density determination of the transported spoil.

In the case of hydraulic transport, volume gauging is also expensive because a separator for separating spoil from the carrier liquid is required. It is also known to use belt weighers or simply to measure the volume of the transported spoil. In addition to the associated measurement inaccuracies, in all methods there is also the error source that exact in-situ determination of the bulk density of the soil to be extracted is scarcely possible. Overall, significantly incorrect soil removal may therefore occur.

Attempts to carry out such measurements are known for example from DE102005038313A1, U.S. Pat. No. 4,152,027A and JPS59154293A. A disadvantage is that these measurements can be carried out only when the boring is stopped.

It is therefore the object to provide a monitoring device, a method and a boring device of the type mentioned in the introduction, with which an excessively high or insufficient delivery rate of spoil can reliably be established promptly directly during the boring.

The technical problem is solved in respect of the monitoring device with the features of claim 1, in respect of the boring device with the features of claim 10 and in respect of the method with the features of claim 15. Preferred exemplary embodiments of the monitoring device according to the invention, of the method according to the invention and of the boring device according to the invention may be found in the dependent claims.

In respect of the monitoring device, the invention proposes a monitoring device for monitoring a removal quantity of loosened soil and/or an overcut to create an annular space when creating a bore in the soil by means of advancing a boring device, wherein the monitoring device can be arranged below an opening in a circumferential wall of a boring device or below an opening of an outer wall of a pipe portion of a boring device or of an expansion pipe, wherein the boring device is a boring device for creating a bore in the soil from a starting point to a destination point, wherein the monitoring device has a compartment, which has an internal space and an access opening to be arranged in the region of the opening, wherein the monitoring device has a gauge element that is arranged pivotably about a pivot axle in the internal space, wherein an actuator in communication with the gauge element is provided, wherein the gauge element can be moved via the actuator in a pivoting direction, wherein the gauge element has a pivoting range so that the gauge element can be moved through the access opening, and wherein the gauge element has at least one contact surface which is in contact with the borehole wall/the soil when the gauge element is pivoted out.

In this way, it is readily possible to establish over/under-removal continuously at least in portions during the boring. An inaccurate quantity or volume measurement of the spoil is avoided. The control can establish whether the surrounding soil is possibly becoming increasingly looser, which might indicate that too much soil has been extracted in relation to the rate of advance. As a remedial measure in this case, for example, the rate of advance may be increased/reduced and/or the amount of spoil transported per unit time may be reduced/increased.

According to a further teaching of the invention, the actuator is a spring element, a hydraulic system with at least one hydraulic cylinder, a pneumatic system with at least one pneumatic cylinder, or a rotary drive.

According to a further teaching of the invention, a pressure measuring means for measuring a pressure in the pressure medium of the pneumatic or hydraulic system is provided.

According to a further teaching of the invention, a position measuring means for measuring the position or a position change of the gauge element is provided.

According to a further teaching of the invention, the position measuring means is an angle measuring sensor for monitoring the pivoting of the pivot axle connected to the gauge element.

According to a further teaching of the invention, the compartment has at least one connection through which a liquid, preferentially a bentonite suspension, can be introduced into the compartment.

According to a further teaching of the invention, the contact surface has at least one chamfered region.

According to a further teaching of the invention, the actuator is arranged inside the internal space of the compartment or outside the compartment.

According to a further teaching of the invention, a lever arm is provided between the actuator and the pivot axle if the actuator is arranged outside the compartment.

In respect of the boring device, the invention proposes a boring device for creating a bore in the soil from a starting point to a destination point and for introducing a pipeline into the soil, having a boring head with a cutting device arranged on the boring head for loosening the soil and a circumferential wall as a housing wall of the boring device with at least one monitoring device as explained above.

According to a further teaching of the invention, the circumferential wall has an opening preferentially in the roof, particularly preferentially at the highest point, below which the monitoring device is arranged.

According to a further teaching of the invention, the monitoring device is connected to the measuring and control system of the boring device.

According to a further teaching of the invention, the monitoring device is connected to a bentonite lubricating system of the boring device via at least one connection of the monitoring device.

According to a further teaching of the invention, at least two monitoring devices are provided, which are arranged radially and/or axially offset.

In respect of the method, the invention proposes a method for monitoring a removal quantity of loosened soil and/or an overcut to create an annular space when creating a bore in the soil by means of advancing a boring device, preferentially a boring device as described above, in the soil by loosening the soil by means of a cutting device from a starting point to a destination point, characterized in that an earth pressure exerted on the boring device is ascertained continuously at least in portions by means of a gauge element, deployed from the circumferential wall of the boring device by pivoting, of a monitoring device, preferentially a monitoring device as described above, in a region behind the cutting device during the boring in order thereby to ascertain over/under-removal of the loosened soil, or in that a change in a position of the gauge element of a monitoring device, preferentially a monitoring device as described above, in a region behind the cutting device is ascertained continuously at least in portions during the boring in order thereby to ascertain over/under-removal of the loosened soil.

In this way, it is readily possible to establish over/under-removal continuously at least in portions during the boring. An inaccurate quantity or volume measurement of the spoil is avoided. The gauging can establish whether the surrounding soil is possibly becoming increasingly looser, which might indicate that too much soil has been extracted in relation to the rate of advance. As a remedial measure in this case, for example, the rate of advance may be increased/reduced and/or the amount of spoil transported per unit time may be reduced/increased.

According to a further teaching of the invention, the pivoting of the gauge element takes place hydraulically or pneumatically.

According to a further teaching of the invention, a change in the earth pressure is established by means of measuring the pressure in a pressure medium used in the pneumatic or hydraulic system and/or by means of a position change of the gauge element.

According to a further teaching of the invention, a fraction, preferably at most 20%, further preferably at most 10%, further preferably at most 5%, of the passive earth pressure of the surrounding soil is applied to the pressure medium.

The boring device may be any machine, for example a full-face machine or a part-face machine. The use of the method is also independent of the type of transport of the extracted soil, for example by means of buckets, screw transport or liquid transport.

The gauge element may have various geometries. For example, a gauge element whose outer wall continues the shape of the circumferential wall forming the circumference of the boring device in the undeployed state and which performs a pivoting movement for the deployment may be envisioned. The gauge element could therefore, for example, protrude in the manner of a fin from the circumferential wall of the boring device in the deployed state.

Not every soil composition may be unproblematic for carrying out the method according to the invention. The method can, however, be adapted to a variety of soil compositions. For the method according to the invention, it is not necessary to establish very minor pressure changes in the earth pressure in order to respond thereto with changes in the rate of advance and/or the amount of spoil transported per unit time. The method according to the invention is effective even when a large reduction in the earth pressure, which implies over-removal of soil, can be established.

The method according to the invention may be carried out so that a change in the earth pressure is established by means of measuring the pressure in a pressure medium used in the hydraulic or pneumatic system and/or by means of a position change of the gauge element.

If too much soil is transported away, the earth pressure on the boring device, and therefore on the gauge element, is reduced. The gauge element therefore tends toward an outward movement so that a pressure reduction takes place in the pressure medium, which may for example be water or oil.

In order to be able to establish a reduction in the earth pressure, the gauge element protrudes at least partly from the circumferential wall of the boring device, for example by a value of up to 20 mm or more. In order to keep the position of the gauge element stable despite a reduction in the ground soil pressure, the pressure of the pressure medium is adapted, i.e. reduced, in an automated fashion and, in the event of falling below a limit value of the pressure or a pressure change, a signal is preferably emitted in an automated fashion or an action is triggered in order to reduce the rate of advance and/or the amount of spoil transported per unit time. If a sufficient increase in the ground soil pressure is established by means of the gauge element, the rate of advance and/or amount of spoil transported per unit time may be increased again.

Alternatively, with a preset initial pressure of the pressure medium, a change in the position of the gauge element may be established. The gauge element may first be brought into an initial position in which the gauge element protrudes at least partly from the circumferential wall of the boring device, for example by up to 20 mm or up to 50 mm. Larger values are likewise possible. The gauge element is preferably blocked against movement from the initial position in the direction of the interior of the boring device, so that up to a maximum load only a movement into the soil or from there back into the initial position is possible. In order to prevent damage when the maximum load is exceeded, a pressure relief valve may for example be used.

The initial pressure may be selected according to the soil consistency and/or soil composition. It may be advantageous to adjust the initial pressure so that it is equal to a fraction of the passive earth pressure, for example at most 20%, further preferably at most 10% or further preferably at most 5%. In this case, only a local massive reduction in the passive earth pressure in the soil allows an outward movement of the gauge element, which is a strong indicator of significant over-removal. Since in an advantageous embodiment of the method according to the invention only a small fraction of the passive earth pressure is selected for the initial pressure, the former does not necessarily need to be ascertained accurately beforehand. Rather, a rough estimate of the passive earth pressure with known or assumed ground soil compositions may be sufficient.

Gauging of the earth pressure on the boring device may therefore take place by pressure measurement in the pressure medium and/or by a position change measurement or displacement measurement at the gauge element. The term earth pressure generally means the pressure that the soil exerts in the given conditions on a surface, here in particular the jacking apparatus, and is used in the present case as a distinction from the technical terms “passive earth pressure” and “active earth pressure”.

Preferentially, the gauge element is arranged in the region of the roof, i.e. at an upper point of the jacking apparatus, since a decrease in the earth pressure due to over-removal is most clearly noticeable there.

The gauge element should preferably be installed as close as possible behind the tip of the machine in order to detect over-removal of the ground soil promptly.

An exemplary embodiment of the method according to the invention and of the boring device according to the invention is presented below with the aid of figures, in which:

FIG. 1 shows a lateral cross section of the front end of a boring device having a first embodiment of a monitoring device according to the invention with a gauge element,

FIG. 2 shows the monitoring device in the retracted state of the gauge element in an enlarged detail of the boring device according to FIG. 1,

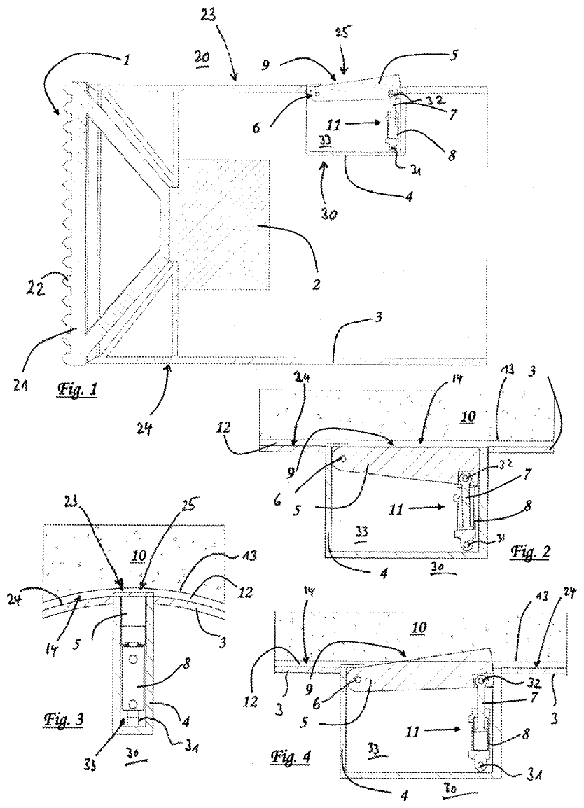

FIG. 3 shows the monitoring device according to FIG. 2 in the retracted state of the gauge element in axial cross section,

FIG. 4 shows the monitoring device according to FIG. 2 in lateral cross section in the deployed state of the gauge element,

FIG. 5 shows a side view of a second embodiment of a monitoring device according to the invention with a retracted gauge element, and

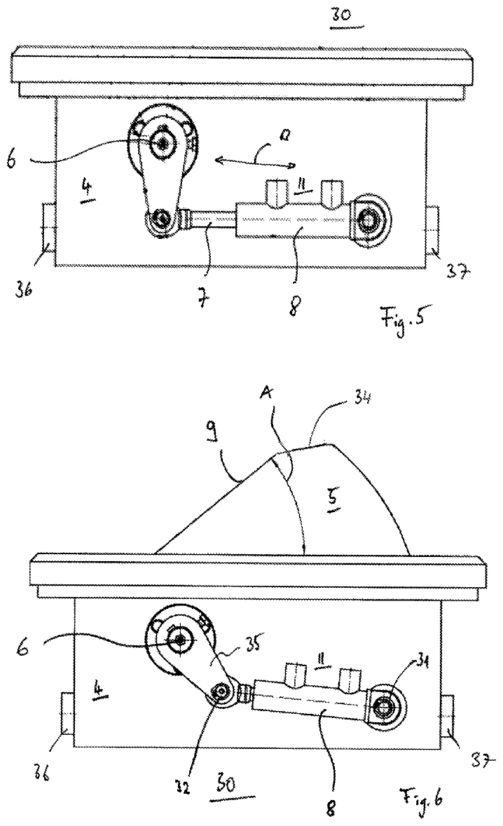

FIG. 6 shows a side view of a second embodiment of a monitoring device according to the invention with a gauge element deployed from FIG. 5.

FIG. 1 schematically shows a lateral cross section of the front part of a tubular boring device 20 having a circumferential wall 3, with a boring head 1 having a cutting wheel 21 with boring tools 22 for loosening soil 10 and a motor unit 2 for driving the cutting wheel 21.

On the circumferential wall 3, in this case preferentially in the region of its highest point 23, particularly preferentially as close as possible to the cutting wheel 21, a first embodiment of a monitoring device 30 according to the invention for monitoring the annular space 14 between the outer side 24 of the circumferential wall 3 and the borehole wall 13 is provided. Alternatively, a second embodiment of the monitoring device 30 according to the invention may correspondingly also be arranged here.

The monitoring device 30 is preferentially arranged below an opening 25 in the circumferential wall 3. The monitoring device 30 has a box-like compartment 4. In an internal space 33 of the box-like compartment 4, a wedge-shaped gauge element 5 is arranged pivotably about a pivot axle 6. The gauge element 5 is linked to a piston 7 of a hydraulic cylinder 8, the hydraulic cylinder 8 being pivotable about a pivot axle 31 relative to the compartment 4 and about a pivot axle 32 relative to the gauge element 5.

The gauge element 5 may have a contact surface 9, which in the deployed state of the gauge element 5 is in contact with the soil 10, or with the borehole 13.

Preferentially, the contact surface 9 may have a chamfered region 34, as is represented by way of example in FIG. 6. Because of the chamfered region 34, it is readily possible that a maximally large or constant region of the contact surface 9 is in contact with the soil 10/the borehole wall 14 from the start, in order to achieve a maximum measurement accuracy. Alternatively or in addition, the shape of the contact surface 9 may also be adapted so that, according to the degree of deployment of the gauge element 5, the region of the contact surface that is in contact with the soil is as constant as possible in order to achieve a measurement accuracy that is as consistent as possible.

Via the hydraulic cylinder 8 and the piston 7, referred to below together as the hydraulic system 11, the gauge element 5 can be brought from a retracted position (see FIG. 2 and FIG. 3) into a deployed position (see FIG. 1 and FIG. 4) in a deploying direction B represented as an arrow, by the gauge element 5 being deployed and retracted, or deployable and retractable, by pivoting about the pivot axle 6 in a pivoting direction A represented as an arrow.

The gauge element 5 has an upper contact surface 9. In the deployed position of the gauge element 5, this surface protrudes at least partly from the compartment 4 through the opening 25, and therefore also beyond the circumference of the circumferential wall 3.

FIG. 2 shows an enlarged detail of the boring device 20 having the box-like compartment 4, the gauge element 5, the piston 7 and the hydraulic cylinder 8, together with the soil 10 surrounding the boring device 20. The gauge element 5 is arranged in the retracted state with its contact surface 9 substantially flush with the circumference of the circumferential wall 3.

FIG. 3 shows the situation according to FIG. 2 in axial cross section. FIG. 4 shows a representation corresponding to FIG. 2 of the gauge element 5 in a deployed position, in which the contact surface 9 of the gauge element 5 protrudes into the soil 10.

FIGS. 5 and 6 show a second embodiment of a monitoring device 30 according to the invention, here represented in a simplified manner without the boring device 20. The drive system, here preferentially in the form of a hydraulic system 11, is arranged outside the compartment 4. The pivot axle 6 is connected to a lever arm 35, which is pivotably connected to the piston 7 via the pivot axle 32. The hydraulic cylinder 8 is furthermore pivotably connected via the pivot axle 31 to the compartment 4. The gauge element 5 is retracted and deployed through actuation of the hydraulic cylinder 8 by moving the lever arm 35 in the pivoting direction A.

The gauge element 5 has a contact surface 9, which preferentially has a chamfered region 34. This may also be provided in the first embodiment of the monitoring device according to the invention.

The compartment 4 furthermore preferentially has connections 36, 37, through which the compartment 4 may for example be flushed with bentonite suspension or water so that soil 10 that has entered the compartment 4 through the opening can be removed therefrom.

The compartment 4 may furthermore be filled by means of bentonite suspension through the connections 36, 37, and optionally pressurized, so as to prevent or reduce the likelihood of soil 10 or bentonite suspension entering the compartment through the opening 25 from the annular space 14, which is fouled with loosened soil.

Furthermore, the opening may in addition preferentially contain a seal (not represented) through which the gauge element 5 moves and which prevents soil 10 from entering the compartment 4.

In addition (not represented), an angle sensor may be provided at the pivot axle 6 and/or a displacement sensor may be provided in the hydraulic system 11, with which the extent to which the gauge element is retracted or deployed can be ascertained.

The hydraulic system may furthermore contain a pressure sensor (not represented) with which a pressure acting on the gauge element 5, or on its contact surface 9, or the change in the pressure acting on the contact surface 9 is measured/ascertained.

The exemplary procedure is as follows: from a launch pit (not represented here), the boring device 20 is driven into the soil 10, for example with a rotating boring head 1. Alternatively, shield tunneling may also be used. The boring head 1 has a diameter slightly larger than the circumference of the circumferential wall 3 of the boring device 20, by which the so-called overcut is excavated. This creates an annular space 14 between the borehole wall 13 and the outer side 24 of the circumferential wall 3. For example, lubricating material 12, for example a bentonite suspension, which reduces the friction of the circumferential wall 3 and subsequently also of the outer side of the pipe to be laid in relation to the soil 10, may be introduced into the annular space 14 via lines (not represented here) and optionally openings (not represented) provided in the circumferential wall 3.

Extracted soil 10, i.e. the spoil, may be discharged by adding a liquid, for example water or bentonite suspension, via lines (not represented here) in the direction of the launch pit. Alternative ways of transporting it away are likewise possible, for example via a screw, belt or bucket conveyor (likewise not represented here) arranged in the interior of the boring device 20.

With the penetration of the boring device 20 into the soil 10, or shortly thereafter, the gauge element 5 is brought by means of the hydraulic system 11 into a deployed position (see FIGS. 1, 4 and FIG. 6) so that the contact surface 9, which is preferably flat but may also assume other shapes, comes in contact with the surrounding soil 10.

After the deployment, a continuous measurement of the overcut, or the amount of soil removed, or over/under-removal of the soil is possible as the boring progresses. Preferentially, the measurement takes place over a prolonged portion, for example in previously identified portions of the bore or along the entire length of the tunnelling of the bore from the launch pit to the destination pit.

According to one possibility, the pressure of a pressure medium in the hydraulic system 11 with the gauge element 5 deployed is adjusted so that there is an equilibrium between the torques that are exerted on the gauge element 5, on the one hand via the pressure of the soil 10 and on the other hand via the piston 7.

If the pressure of the soil 10 abates, for example because a cavity is formed in the roof over the borehole, the pressure in the hydraulic system 11 needs to be lowered correspondingly in order to maintain the position of the gauge element 5, so that the reduction in the earth pressure can be established via the pressure in the hydraulic system 11. Such a reduction in the earth pressure implies that over-removal of soil 10 has taken place, so that for example the delivery rate of the spoil may be reduced and/or the rate of advance of the boring device 20 may be increased as a countermeasure in order to prevent sinking or undesired dispersal of the soil 10.

If the pressure of the soil 10 rises, for example because too little soil 10 has been loosened by the cutting wheel 21 and subsequently transported away, the pressure in the hydraulic system 11 needs to be increased correspondingly in order to maintain the position of the gauge element 5, so that the increase in the earth pressure can be established via the pressure in the hydraulic system 11. Such an increase in the earth pressure implies that under-removal of soil 10 has taken place, so that for example the delivery rate of the spoil may be increased and/or the rate of advance of the boring device 20 may be reduced as a countermeasure in order to prevent outward bulging or undesired compaction of the soil 10. It may possibly also be necessary to change the boring tools 22, particularly in the edge region of the cutting wheel 21, since they may be worn.

Furthermore, it is also possible to establish shrinkage of the borehole in the radial direction with the monitoring device 30. For this purpose, it may be advantageous to provide a plurality of monitoring devices offset from one another, for example by 20 to 30 degrees, on the circumferential wall in the region of the roof of the bore. Furthermore, it is advantageous to space them apart axially from one another.

As an alternative to measuring the pressure in the hydraulic system 11, or in parallel therewith, the deployment length of the piston 7 or the position of the gauge element 5 relative to further parts of the jacking apparatus, for example the circumferential wall 3, may also be measured with suitable methods in order to establish a variation in the earth pressure exerted on the gauge element 5 by the soil 10.

For this purpose, for example, an initial pressure that is a fraction, for example 10%, of the passive earth pressure of the surrounding soil 10 may be adjusted in the hydraulic system. From an initial position of the gauge element 5, in which the gauge element 5 protrudes with its contact surface 9 from the circumferential wall 3 of the boring device 20, preferentially for example by 20-50 mm, particularly preferentially 30 mm, the gauge element 5 is then pressed outward if the earth pressure is less than 10% of the passive earth pressure. With this movement, over-removal of spoil in the soil 10 can be established straightforwardly but accurately.

In order to prevent ingress of soil 10 into the compartment 4, the compartment 4 may be filled with a material that does not interfere with the functions of the hydraulic system 11, for example bentonite suspension, preferentially via the connections 36, 37. It is preferably at a pressure corresponding at least substantially to the pressure of the lubricating material 12 in order to prevent entry of the lubricating material 12 possibly also containing soil 10.

It is also conceivable not only to link the gauge element 5 pivotably, but also to impart a translational movement to it.

The features of the device and of the method that are presented in the exemplary embodiments represented may be replaced or supplemented in the context of the invention with alternative or further features, for example such as are presented in the general part of the description or are apparent to a person skilled in the art.

### LIST OF REFERENCE SIGNS

1 boring head
2 motor unit
3 circumferential wall
4 compartment
5 gauge element
6 pivot axle
7 piston
8 hydraulic cylinder
9 contact surface
10 ground soil
11 hydraulic system
12 lubricating material
13 borehole wall
14 annular space
20 boring device
21 cutting wheel
22 boring tool
23 highest point
24 outer side
25 opening
30 monitoring device
31 pivot axle
32 pivot axle
33 internal space
34 chamfered region
35 lever arm
36 connection
37 connection

1-18. (canceled)

19. A monitoring device for monitoring a removal quantity of loosened soil or monitoring an overcut of an annular space when creating a bore in the soil by advancing a boring device from a starting point to a destination point, wherein the monitoring device is placed under an aperture in a circumferential wall, the circumferential wall being one of a boring device housing or an outer wall of a pipe portion or of an expansion pipe, comprising;
a compartment, which has an internal space with an access opening in the region of the aperture;
a gauge element that is arranged pivotably about a pivot axle in the internal space;
an actuator in communication with the gauge element, wherein
the gauge element is pivotable by the actuator through a pivoting range sufficient that the gauge element can be moved through the access opening and through the aperture; and
the gauge element has at least one contact surface which is in contact with at least one of a borehole wall or the soil when the gauge element is pivoted through the aperture.

20. The monitoring device as claimed in claim 19, wherein the actuator is one of a spring element, a hydraulic system with at least one hydraulic cylinder, a pneumatic system with at least one pneumatic cylinder, or a rotary drive.

21. The monitoring device as claimed in claim 20, further comprising a pressure measuring element configured to measure a pressure in a pressure medium of one of the pneumatic system or hydraulic cylinder.

22. The monitoring device as claimed in claim 19, further a position measuring element configured to measure one of the position or a position change of the gauge element.

23. The monitoring device as claimed in claim 22, wherein the position measuring element is an angle measuring sensor configured to monitor the pivoting of a pivot axle connected to the gauge element.

24. The monitoring device as claimed in claim 19, wherein the compartment has at least one connection through which a liquid can be introduced into the compartment.

25. The monitoring device as claimed in claim 24, wherein the liquid is a bentonite suspension.

26. The monitoring device as claimed in claim 19, wherein the contact surface comprises at least one chamfered region.

27. The monitoring device as claimed in claim 19, wherein the actuator is arranged at least one of inside the internal space of the compartment or outside the compartment.

28. The monitoring device as claimed in claim 27, further comprising a lever arm between the compartment and the pivot axle when the actuator is arranged outside the compartment.

29. A boring device for creating a bore in soil from a starting point to a destination point for laying a pipeline into the soil; comprising,
a boring head, with a cutting device on the boring head, to loosen the soil;
a housing of the boring device;
at least one monitoring device, wherein the monitoring device is disposed below an aperture in the housing, the monitoring device comprising;
a compartment, which has an internal space with an access opening in the region of the aperture;
a gauge element that is arranged pivotably about a pivot axle in the internal space;
an actuator in communication with the gauge element, wherein
the gauge element is pivotable by the actuator through a pivoting range sufficient that the gauge element can be moved through the access opening and through the aperture; and
the gauge element has at least one contact surface which is in contact with at least one of the borehole wall or the soil when the gauge element is pivoted through the aperture.

30. The boring device as claimed in claim 29, wherein the opening is on a upper portion of the housing, including the highest point.

31. The boring device as claimed in claim 30, wherein the opening is arranged at the highest point.

32. The boring device as claimed in claim 29, wherein the monitoring device is connected to a measuring and control system of the boring device.

33. The boring device as claimed in claim 29, wherein the monitoring device is connected to a bentonite lubricating system of the boring device via at least one connection of the monitoring device.

34. The boring device as claimed in claim 29, wherein at least two monitoring devices are provided, which are arranged at least one of radially or axially offset.

35. A method for monitoring a removal quantity of loosened soil or an overcut to create an annular space when creating a bore in the soil by means of advancing a boring device in the soil by loosening the soil with a cutting device from a starting point to a destination point, comprising;
continuously measuring an earth pressure, at at least one portion of the annular space using a monitoring device deployed from a circumferential wall of the boring device or a pipes section;
pivoting a gauge element of the monitoring device to be in contact with at least one of the borehole wall or the soil;
measuring at least one of the pressure applied to, or displacement of, the gauge element in a region behind the cutting device during the boring to determine over-removal or under-removal of the loosened soil,.

36. The method as claimed in claim 35, wherein the pivoting of the gauge element is produced one of by a hydraulic or pneumatic system.

37. The method as claimed in claim 35, wherein a change in the earth pressure is established by measuring the pressure in a pressure medium used in the pneumatic or hydraulic system.

38. The method as claimed in claim 35, wherein a fraction of the passive earth pressure of the surrounding soil is applied to the pressure medium, the fraction being at least one of 20%, 10%, or 5%.
